(19) United States
(12) Patent Application Publication
(10) Pub. No.: US 2012/0214949 A1
(43) Pub. Date: Aug. 23, 2012

(54) POLYMER, GAS SEPARATION MEMBRANE, AND PROCESS FOR PRODUCTION OF POLYMER

(75) Inventors: Toshiki Aoki, Niigata-shi (JP); Masahiro Teraguchi, Niigata-shi (JP); Takashi Sato, Tsukuba-shi (JP); Taketsugu Yamamoto, Tsukuba-shi (JP)

(73) Assignees: SUMITOMO CHEMICAL COMPANY, LIMITED, Tokyo (JP); NIIGATA UNIVERSITY, Niigata-shi, Niigata (JP)

(21) Appl. No.: 13/391,086

(22) PCT Filed: Aug. 12, 2010
(86) PCT No.: PCT/JP2010/063708

§ 371 Date: May 3, 2012

(30) Foreign Application Priority Data
Aug. 18, 2009 (JP) 2009-189201

(51) Int. Cl. C08F 30/08; C08F 8/18

(52) U.S. Cl. 525/326.5; 525/359.4

(57) ABSTRACT

A polymer having a repeating unit represented by formula (1).

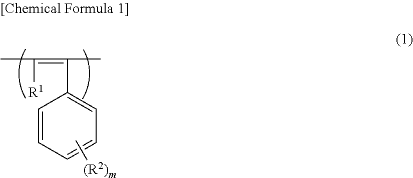

[R¹ represents a hydrogen atom, a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group, each R² is independently represented by the following formula (2), m is an integer of from 1 to 5, and when a plurality of R²s are present, the R²s may be the same as or different from each other.]

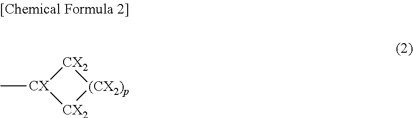

[Each X is independently a monovalent group, and the plurality of Xs may be the same as or different from each other, at least one X is a monovalent group containing a halogen atom, and p is an integer of from 0 to 10.]

### TECHNICAL FIELD

The present invention relates to a polymer, a gas separation membrane, and a process for producing a polymer.

### BACKGROUND ART

As the range for applications of polymers continues to widen, functional polymers provided with various functions, such as gas separability, are being studied. As functional polymers with gas separability there are known substituted diphenylacetylene polymers having a substituent introduced on the phenyl group (sec Patent document 1). Gas separation membranes of diphenylacetylene polymers with a C₆H₁₁ group introduced as a substituent on a phenyl group are also being investigated (see Non-patent document 1).

### CITATION LIST

### Patent Literature

[Patent document 1] JP 05-271338 A

### Non-Patent Literature

[Non-patent document 1] Hu, Y, Shiotsuki, M., Sanada, F., Masuda, T. Polymer Journal, 39, 968-971 (2007).

### SUMMARY OF INVENTION

### Technical Problem

However, substituted diphenylacetylene polymers having cycloalkyl groups introduced as a substituent on a phenyl group are not examined in Patent document 1, and the gas separating function of such polymers, i.e. the oxygen permeability coefficient and the oxygen/nitrogen selective permeability as defined by the oxygen permeability coefficient/nitrogen permeability coefficient, is unknown. Moreover, while Non-patent document 1 discloses a diphenylacetylene polymer having a C₆H₁₁ group introduced as a substituent on a phenyl group (poly(1a)), the oxygen permeability coefficient of the polymer is insufficient, at 230×10⁻¹⁰.

It is an object of the invention to provide a polymer that is superior in terms of both oxygen permeability coefficient and oxygen/nitrogen selective permeability.

### Solution to Problem

The present invention provides a polymer, a gas separation membrane and a process for producing a polymer, as described below.

The polymer of the invention has a repeating unit represented by the following formula (1).

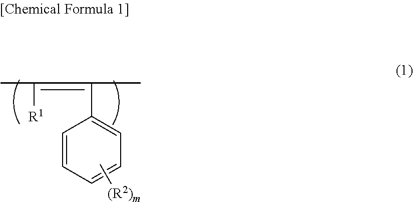

In formula (1), R¹ represents a hydrogen atom, a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group, each R² is independently represented by the following formula (2), m is an integer of from 1 to 5, and when a plurality of the R²s are present, the R²s may be the same as or different from each other.

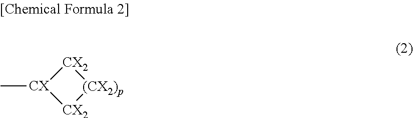

In formula (2), each X is independently a monovalent group, the plurality of Xs may be the same as or different from each other, at least one X is a monovalent group containing a halogen atom, and p is an integer of from 0 to 10.

The polymer of the invention comprise the repeating unit described above, thereby having high oxygen permeability and high oxygen/nitrogen selective permeability.

According to the invention, at least one X is preferably a halogeno group, and more preferably at least one X is a fluoro group. All of the Xs are preferably halogeno groups, and more preferably all of the Xs are fluoro groups.

This allows an effect of further improving the oxygen/nitrogen selective permeability of the polymer due to further increase of the affinity between the polymer and oxygen, and of improving the heat resistance of the polymer as well.

According to the invention, R¹ is preferably an unsubstituted phenyl group, or a substituted phenyl group represented by the following formula (3).

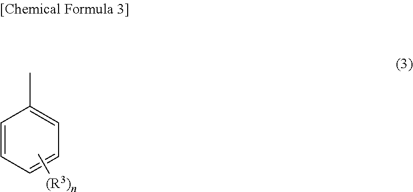

In formula (3), each R³ independently represents a monovalent group, n is an integer of from 1 to 5, and when a plurality of R³s are present, the R³s may be the same as or different from each other.

If R¹ has such a structure, the oxygen permeability of the polymer and the oxygen/nitrogen selective permeability of the polymer can be further improved, and aging deterioration of the polymer can be suppressed.

R³ is preferably a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group, thereby still further improving the oxygen permeability of the polymer and the oxygen/nitrogen selective permeability of the polymer, and aging deterioration of the polymer can also be suppressed.

R³ is more preferably a halogeno group, a substituted or unsubstituted alkyl group, or a trialkylsilyl group, even more preferably a fluoro group or a trimethylsilyl group, and most preferably a trimethylsilyl group, thereby still further improving the oxygen permeability and oxygen/nitrogen selective permeability of the polymer and aging deterioration of the polymer can be suppressed, and it also results in superior film formability of the polymer, due to better solubility in various organic solvents.

R¹ is preferably an unsubstituted phenyl group, in which case the poor solubility of the polymer in solvents makes it easier to realize a gas separation membrane with high resistance to solvents.

The present invention provides a process for producing a polymer, which comprises a step of subjecting a polymer comprising a repeating unit represented by the following formula (C), into contact with a di(halogenocycloalkylcarboxy)peroxide represented by the following formula (D) or a (halogenocycloalkyl)phenyliodoniumtrifluoromethane sulfonate represented by the following formula (E) or both.

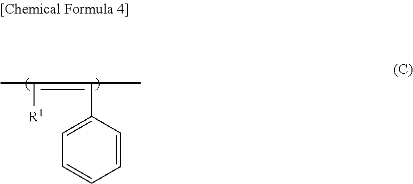

[In formula (C), R¹ represents a hydrogen atom, a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group.]

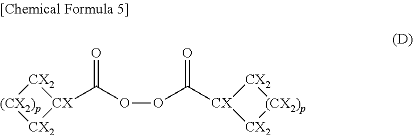

[In formula (D), each X is independently a monovalent group, the plurality of Xs may be the same as or different from each other, at least one X is a monovalent group containing a halogen atom, each p is independently an integer of from 0 to 10, the two p values may be the same as or different from each other.]

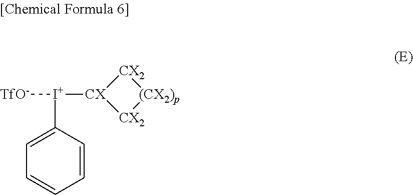

[In formula (E), each X is independently a monovalent group, the plurality of Xs may be the same as or different from each other, at least one X is a monovalent group containing a halogen atom, p is an integer of from 0 to 10, and TfO⁻ represents a trifluoromethanesulfonate ion.] The superior polymer described above can be obtained according to this method.

### Advantageous Effects of Invention

According to the invention it is possible to provide a polymer that is superior in terms of both oxygen permeability and oxygen/nitrogen selective permeability.

### DESCRIPTION OF EMBODIMENTS

Preferred embodiments of the invention will now be described in detail.

### [Polymer]

The polymer of this embodiment has a repeating unit represented by the following formula (1).

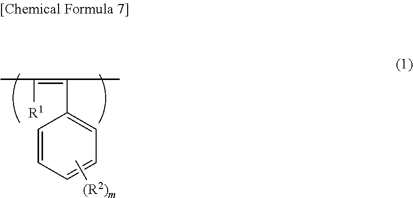

The polymer comprises a plurality of repeating units represented by formula (1), and the plurality of repeating units may have the lateral positions of R¹ and the (R²)ₘ, introduced phenyl group reversed to each other. The plurality of repeating units represented in the polymer may each independently be cis or trans forms. Cis or trans forms can be identified by Raman spectrophotometry of the polymer film.

(Functional Group R¹)

In formula (1), R¹ represents a hydrogen atom, a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group.

Throughout the present specification, an “aromatic hydrocarbon group” refers to an atomic group remaining after removing a hydrogen atom bonded to a carbon atom composing the aromatic ring of an aromatic hydrocarbon. An “aromatic heterocyclic group” refers to an atomic group remaining after removing a hydrogen atom bonded to a carbon atom or a heteroatom composing the aromatic heterocycle of an aromatic heterocyclic compound. An “aromatic heterocyclic compound” refers to an organic compound having an aromatic cyclic structure, wherein the elements composing the ring include not only carbon atoms but also a heteroatom such as an oxygen atom, sulfur atom, nitrogen atom, phosphorus atom, boron atom, silicon atom, selenium atom, tellurium atom or arsenic atom.

Examples of a halogeno group as R¹ in formula (1) include a fluoro group, a chloro group, a bromo group, and an iodo group. Fluoro groups and chloro groups are preferred among these.

Examples of substituted or unsubstituted alkyl groups for R¹ in formula (1) include methyl group, ethyl group, propyl group, butyl group, pentyl group, hexyl group, isopropyl group, isobutyl group, tertiary butyl group, 1-methylpropyl group, isopentyl group, 1-methylbutyl group, 2-methylbutyl group, 1,1-dimethylpropyl group, 1-methylpentyl group, 1,1-dimethylpentyl group and 2-methylpentyl group, and these groups wherein some or all of the hydrogens have been replaced by halogeno groups. Specific examples of substituted alkyl groups include chloromethyl group, chloroethyl group, chloropropyl group, dichloromethyl group, dichloroethyl group, trichloromethyl group, bromomethyl group, bromoethyl group, bromopropyl group, dibromomethyl group, dibromoethyl group, monofluoromethyl group, monofluoroethyl group, trifluoromethyl group, perfluoroethyl group, perfluoropropyl group, perfluoroisopropyl group, perfluoroisobutyl group, perfluoro-1-methylpropyl group, perfluoropentyl group, perfluorobutyl group, perfluoroisopentyl group, perfluorohexyl group, perfluoroheptyl group, perfluorooctyl group, perfluorononyl group, perfluorodecyl group, perfluoroundecyl group and perfluorododecyl group. Among them perfluoro-substituted forms are preferred.

Examples of a substituted or unsubstituted aromatic hydrocarbon group for R¹ in formula (1) include unsubstituted aromatic hydrocarbons groups, and aromatic hydrocarbon groups substituted with a halogeno group, an alkoxy group, an alkyl group, a trialkylsilyl group, or a trialkylgermyl group.

Examples of aromatic hydrocarbon groups include those with fused rings, and those having 2 or more of independent benzene rings or fused rings bonded by a single bond or a divalent organic group. The number of carbon atoms in the aromatic hydrocarbon group is usually from 6 to 60, preferably from 6 to 30 and more preferably from 6 to 20. Examples of aromatic hydrocarbon groups include phenyl group, C₁-C₁₂ alkoxyphenyl group, C₁-C₁₂ alkylphenyl group, trialkylsilylphenyl group, trialkylgermylphenyl group, 1-naphthyl group, 2-naphthyl group, 1-anthracenyl group, 2-anthracenyl group, 9-anthracenyl group, pyrenyl group, perylenyl group and pentafluorophenyl group, with phenyl group, C₁-C₁₂ alkylphenyl group and trialkylsilylphenyl group being preferred.

Examples of substituted or unsubstituted aromatic heterocyclic groups for R¹ in formula (1) include unsubstituted monovalent aromatic heterocyclic groups, and monovalent aromatic heterocyclic groups substituted with substituents such as alkyl groups.

The number of carbon atoms in a monovalent aromatic heterocyclic group is usually from 4 to 60, preferably from 4 to 30 and more preferably about from 4 to 20, not including the number of carbon atoms of the substituents. Monovalent aromatic heterocyclic groups include thiophenyl group, C₁-C₁₂ alkylthiophenyl group, pyrroyl group, furyl group, pyridyl group, C₁-C₁₂ alkylpyridyl group, pyridazyl group, pyrimidyl group and pyrazinyl group.

Examples of trialkylsilyl groups for R¹ in formula (1) include trimethylsilyl group, triethylsilyl group, tri-isopropylsilyl group, dimethyl-isopropylsilyl group, diethyl-isopropylsilyl group, pentyldimethylsilyl group, hexyldimethylsilyl group, heptyldimethylsilyl group, octyldimethylsilyl group, octyldiethylsilyl group, 2-ethylhexyldimethylsilyl group, nonyldimethylsilyl group, decyldimethylsilyl group, 3,7-dimethyloctyl-dimethylsilyl group and dodecyldimethylsilyl group.

Examples of trialkylgermyl groups for R¹ in formula (1) include trimethylgermyl group, triethylgermyl group, tri-isopropylgermyl group, dimethyl-isopropylgermyl group, diethyl-isopropylgermyl group, pentyldimethylgermyl group, hexyldimethylgermyl group, heptyldimethylgermyl group, octyldimethylgermyl group, octyldiethylgermyl group, 2-ethylhexyldimethylgermyl group, nonyldimethylgermyl group, decyldimethylgermyl group, 3,7-dimethyloctyl-dimethylgermyl group and dodecyldimethylgermyl group.

R¹ is preferably unsubstituted phenyl group or a substituted phenyl group represented by the following formula (3).

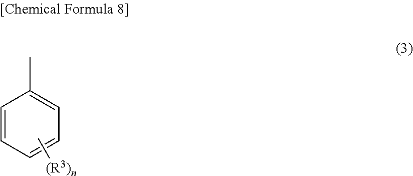

In formula (3), each R³ independently represents a monovalent group, n is an integer of from 1 to 5, and when a plurality of R³s are present, the R³s may be the same as or different from each other.

If R¹ is one of these structures, it is possible to further improve the oxygen/nitrogen selective permeability of the polymer and suppress aging deterioration in the polymer.

R³ may be bonded at the para position, meta position or ortho position with respect to the carbon atom bonded to the main chain of the polymer among the carbon atoms composing the benzene ring in formula (3), and it may be selected as appropriate.

The monovalent group as R³ in formula (3) is preferably a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group.

If R³ is one of these structures, it is possible to further improve the oxygen/nitrogen selective permeability of the polymer and suppress aging deterioration in the polymer.

Examples of a halogeno group as R³ in formula (3) include a fluoro group, a chloro group, a bromo group, and an iodo group, and is preferably a fluoro group, and a chloro group.

Examples of substituted or unsubstituted alkyl groups for R³ in formula (3) include methyl group, ethyl group, propyl group, butyl group, pentyl group, hexyl group, isopropyl group, isobutyl group, tertiary butyl group, 1-methylpropyl group, isopentyl group, 1-methylbutyl group, 2-methylbutyl group, 1,1-dimethylpropyl group, 1-methylpentyl group, 1,1-dimethylpentyl group and 2-methylpentyl group, and these groups wherein some or all of the hydrogens have been replaced by halogeno groups. Specific examples of substituted alkyl groups include chloromethyl group, chloroethyl group, chloropropyl group, dichloromethyl group, dichloroethyl group, trichloromethyl group, bromomethyl group, bromoethyl group, bromopropyl group, dibromomethyl group, dibromoethyl group, monofluoromethyl group, monofluoroethyl group, trifluoromethyl group, perfluoroethyl group, perfluoropropyl group, perfluoroisopropyl group, perfluoroisobutyl group, perfluoro-1-methylpropyl group, perfluoropentyl group, perfluorobutyl group, perfluoroisopentyl group, perfluorohexyl group, perfluoroheptyl group, perfluorooctyl group, perfluorononyl group, perfluorodecyl group, perfluoroundecyl group and perfluorododecyl group. Among them perfluoro-substituted forms are preferred.

Examples of a substituted or unsubstituted aromatic hydrocarbon group for R³ in formula (3) include unsubstituted aromatic hydrocarbon groups, and aromatic hydrocarbon groups substituted with a halogeno group, an alkoxy group, an alkyl group, a trialkylsilyl group, or a trialkylgermyl group. Aromatic hydrocarbon groups also include those with fused rings, and those having 2 or more of independent benzene rings or fused rings bonded by a single bond or a divalent organic group. The number of carbon atoms in the aromatic hydrocarbon group is usually from 6 to 60, preferably from 6 to 30 and more preferably from 6 to 20. Examples of aromatic hydrocarbon groups include phenyl group, C₁-C₁₂ alkoxyphenyl group, C₁-C₁₂ alkylphenyl group, trialkylsilylphenyl group, trialkylgermylphenyl group, 1-naphthyl group, 2-naphthyl group, 1-anthracenyl group, 2-anthracenyl group, 9-anthracenyl group, pyrenyl group, perylenyl group and pentafluorophenyl group, with phenyl group, C₁-C₁₂ alkylphenyl group and trialkylsilylphenyl group being preferred.

Examples of substituted or unsubstituted aromatic heterocyclic groups for R³ in formula (3) include unsubstituted monovalent aromatic heterocyclic groups, and monovalent aromatic heterocyclic groups substituted with substituents such as alkyl groups. The number of carbon atoms in a monovalent aromatic heterocyclic group is usually from 4 to 60, preferably from 4 to 30 and more preferably about from 4 to 20, not including the number of carbon atoms of the substituents. Monovalent aromatic heterocyclic groups include thiophenyl group, C₁-C₁₂ alkylthiophenyl group, pyrroyl group, furyl group, pyridyl group, C₁-C₁₂ alkylpyridyl group, pyridazyl group, pyrimidyl group and pyrazinyl group.

Specific examples of trialkylsilyl groups for R³ in formula (3) include trimethylsilyl group, triethylsilyl group, tri-isopropylsilyl group, dimethyl-isopropylsilyl group, diethyl-isopropylsilyl group, pentyldimethylsilyl group, hexyldimethylsilyl group, heptyldimethylsilyl group, octyldimethylsilyl group, octyldiethylsilyl group, 2-ethylhexyldimethylsilyl group, nonyldimethylsilyl group, decyldimethylsilyl group, 3,7-dimethyloctyl-dimethylsilyl group and dodecyldimethylsilyl group, with trimethylsilyl group, triethylsilyl group, tri-isopropylsilyl group, dimethyl-isopropylsilyl group and diethyl-isopropylsilyl group being preferred, and trimethylsilyl group and triethylsilyl group being more preferred.

Specific examples of trialkylgermyl groups for R³ in formula (3) include trimethylgermyl group, triethylgermyl group, tri-isopropylgermyl group, dimethyl-isopropylgermyl group, diethyl-isopropylgermyl group, pentyldimethylgermyl group, hexyldimethylgermyl group, heptyldimethylgermyl group, octyldimethylgermyl group, octyldiethylgermyl group, 2-ethylhexyldimethylgermyl group, nonyldimethylgermyl group, decyldimethylgermyl group, 3,7-dimethyloctyl-dimethylgermyl group and dodecyldimethylgermyl group, with trimethylgermyl group, triethylgermyl group, tri-isopropylgermyl group, dimethyl-isopropylgermyl group and diethyl-isopropylgermyl group being preferred, and trimethylgermyl group and triethylgermyl group being more preferred.

From the viewpoints of oxygen/nitrogen selective permeability of the polymer, the effect of suppressing aging deterioration of the polymer and the film formability of the polymer, R³ is preferably a halogeno group, a substituted or unsubstituted alkyl group, or a trialkylsilyl group, more preferably a fluoro group or a trimethylsilyl group, and even more preferably a trimethylsilyl group. Trialkylsilyl group and especially trimethylsilyl groups, in particular, can facilitate dissolution of the polymer in the solvent and result in further superior film formability.

R¹ is also preferably an unsubstituted phenyl group. In this case, the poor solubility of the polymer in solvents makes it easier to realize a gas separation membrane with high resistance to solvents.

(Functional Group R²)

R² is represented by the following formula (2). In formula (1), m is an integer of from 1 to 5, and when a plurality of R²s are present, the R²s may be the same as or different from each other.

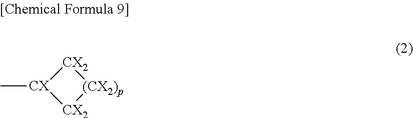

In formula (2), each X is independently a monovalent group, the plurality of Xs may be the same as or different from each other, at least one X is a monovalent group containing a halogen atom, and p is an integer of from 0 to 10.

Examples of monovalent groups containing a halogen atom include halogeno groups, halogenoalkyl groups, halogeno aromatic rings and halogeno aromatic heterocycles.

Examples of halogeno groups include fluoro group (—F), chloro group (—CO, bromo group (—Br), and iodo group (—I).

Examples of halogenoalkyl groups include fluoroalkyl groups and chloroalkyl groups. Examples of fluoroalkyl groups include C1-15 perfluoroalkyl group, monofluoromethyl group, monofluoroethyl group and trifluoroethyl group. Examples of chloroalkyl groups include chloromethyl group, chloroethyl group, dichloroethyl group, chlorpropyl group and trichloromethyl group.

There are no particular restrictions on groups for X that are monovalent groups with no halogen atoms, and examples include hydrogen atom, alkyl groups, branched alkyl groups, aromatic hydrocarbon groups and aromatic heterocyclic groups.

Preferably, at least one X is a halogeno group. More preferably, at least one X is a fluoro group. This allows an effect of further improving the oxygen/nitrogen selective permeability of the polymer due to further increase of the affinity between the polymer and oxygen, and of improving the heat resistance of the polymer as well.

In formula (2), all of the X groups are preferably halogeno groups, and more preferably all of the X groups are fluoro groups. This allows an effect of still further improving the oxygen/nitrogen selective permeability due to still further increase of the affinity between the polymer and oxygen, and of improving the heat resistance of the polymer as well.

In formula (2), p is an integer of from 0 to 10, and from the viewpoints of improving the oxygen permeability coefficient and oxygen/nitrogen selective permeability and of suppressing moisture permeation, p is preferably an integer of from 2 to 5 and more preferably 3.

The polymer of the invention, comprising the repeating unit described above, is superior in terms of both oxygen permeability and oxygen/nitrogen selective permeability. The present inventors believe that one reason that the polymer of the invention exhibits such properties is that due to the presence of the cycloalkyl group in formula (2), which includes at least one halogen atom, the van der Waals force is decreased and the free volume is increased.

The polymer of this embodiment may contain repeating units other than the repeating unit represented by formula (1), but from the viewpoint of highly exhibiting both the oxygen permeability and oxygen/nitrogen selective permeability, the ratio of the content of the repeating unit represented by formula (1) relative to the total repeating units, is preferably 1 wt % or more, more preferably 10 wt % or more and 100 wt % or less, and even more preferably 50 wt % or more and 100 wt % or less.

From the viewpoint of film formability, the weight-average molecular weight (M_{w}) of the polymer is preferably 1×10³ or more and 5×10⁷ or less, more preferably 1×10⁴ or more and 2×10⁷ or less, and even more preferably 1×10⁵ or more and 1×10⁷ or less. From the same viewpoint, the number-average molecular weight (MO of the polymer is preferably 1×10³ or more and 2×10⁷ or less, more preferably 1×10⁴ or more and 1×10⁷ or less, and even more preferably 1×10⁵ or more and 5×10⁶ or less. The variance ratio (M_{w}/Mₙ) which represents the degree of molecular weight distribution of the polymer is preferably 1.0 or more and 10.0 or less, more preferably 1.1 or more and 8.0 or less, and even more preferably 1.1 or more and 5.0 or less. In the invention, the weight-average molecular weight (M_{w}), number-average molecular weight (Mₙ) and variance ratio (M_{w}/M_{w}) of the polymer are determined based on polystyrene standard, by chromatography using tetrahydrofuran as the solvent. The column used may be “GPC KF-807L” of the KF-800 Series by Shodex.

From the viewpoint of thermostability, the 5% weight reduction temperature (T_{d5}) of the polymer is preferably 380° C. or more and 550° C. or less, more preferably 390° C. or more and 500° C. or less, and even more preferably 400° C. or more and 490° C. or less. The 5% weight reduction temperature of the polymer can be measured by thermogravimetry (the apparatus may be, for example, a differential thermal/thermogravimetry apparatus, model DTG-60/60H by Shimadzu Corp.). The temperature-elevating rate during measurement is 10° C./min, with temperature elevation under a nitrogen atmosphere.

The polymer of the invention has been explained above, and the polymer can be developed for a variety of purposes due to its excellence in terms of both oxygen permeability and oxygen/nitrogen selective permeability. The polymer can be used as a gas separation membrane for the following purposes, for example.

(1) A gas purification apparatus which removes nitrogen from air to produce oxygen-enriched air or oxygen.
(2) A gas purification apparatus which removes oxygen from air to produce nitrogen-enriched air or nitrogen.
(3) An air intake mechanism for a fuel cell or the like.

These are merely for illustration, and the range of application of the invention is not limited thereto. There are no particular restrictions on the film thickness when it is to be used as a film, but from the viewpoint of preventing permeation of nitrogen and water vapor and guaranteeing oxygen permeability, it is preferably 0.1 μm or more and 100 μm or less and more preferably 0.1 μm or more and 50 μm or less.

### [Process for Production of Polymer]

The polymer may be produced, for example, by a method of polymerizing a monomer represented by the following formula (A), or a method of adding R² as necessary to a polymer obtained by polymerization of a monomer represented by the following formula (B).

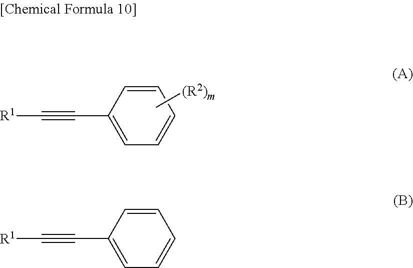

Polymerization of a monomer represented by formula (A) or (B) can be accomplished, for example, by a method of reaction at from 40 to 100° C. for from 2 to 24 hours, in the presence of a transition metal catalyst.

By polymerization of a monomer represented by formula (B) it is possible to obtain a polymer represented by the following formula (C). Addition of R² to a polymer represented by formula (C) may be accomplished, for example, by a method of subjecting a di(halogenocycloalkylcarboxy)peroxide represented by the following formula (D) (for example, a di(perfluorocycloalkylcarboxy)peroxide) into contact with the polymer. Specifically, a method of immersing the polymer represented by formula (C) in a solution comprising a di(halogenocycloalkylcarboxy)peroxide is preferred.

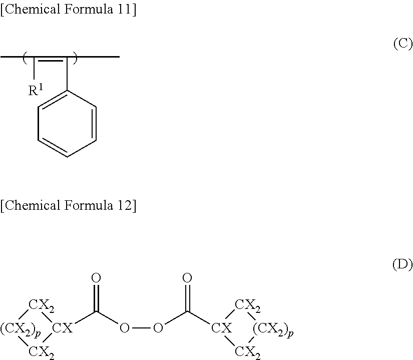

In formula (D), each X is independently a monovalent group, the plurality of Xs may be the same as or different from each other, at least one X is a monovalent group containing a halogen atom, each p is independently an integer of from 0 to 10, and the two p values may be the same as or different from each other. Examples for X are the same ones mentioned above. In both cycloalkane groups, at least one X is preferably a monovalent group comprising a halogen atom.

Addition of R² to a polymer represented by formula (C) may be accomplished by a method of subjecting the polymer into contact with a (halogenocycloalkyl)phenyliodoniumtrifluoromethane sulfonate represented by the following formula (E) (for example, a (perfluorocycloalkyl)phenyliodoniumtrifluoromethane sulfonate). Specifically preferred is a method of immersing a polymer represented by formula (C) in a solution of a (halogenocycloalkyl)phenyliodoniumtrifluoromethane sulfonate dissolved in a chloroform and acetonitrile mixed solvent.

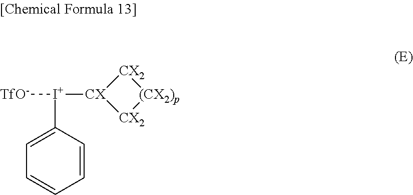

In formula (E), X and p are the same as in formula (2). That is, each X is independently a monovalent group, the Xs may be the same as or different from each other, at least one X is a monovalent group containing a halogen atom, and p is an integer of from 0 to 10. Also, TfO⁻ represents a trifluoromethanesulfonate ion.

### [Process for Producing Gas Separation Membrane]

The gas separation membrane comprising the polymer described above may be produced, for example, by a method of mixing a polymer comprising a repeating unit represented by formula (1) above with a solvent to prepare a film-forming coating solution, and then coating a substrate with the coating solution and evaporating off the solvent.

The solvent used to prepare the film-forming coating solution is preferably one that can dissolve the polymer. Examples of such solvents include organic solvents such as toluene, anisole, chlorobenzene, dichlorobenzene, chloroform and tetrahydrofuran.

The gas separation membrane comprising the polymer may be produced by a method of melting the polymer to form a film.

When either or both the polymer represented by formula (D) and/or the polymer represented by formula (E) is used to obtain the polymer comprising the repeating unit represented by formula (1), it is preferable to form the polymer of formula (C) into a film first, and then subject the polymer represented by formula (D) or the polymer represented by formula (E), or both, into contacted with the film of polymer (C).

Preferred embodiments of the invention will now be explained. However, the invention is in no way limited thereto.

### EXAMPLES

The invention will now be explained in greater detail based on examples and comparative examples. However, the invention is not limited to the examples described below.

### Example 1

After adding tetra-n-butyltin (215 μL, 6.55×10⁻² mmol) to a solution of tantalum pentachloride (143 mg, 0.399 mmol) in toluene (17.1 mL) under a nitrogen atmosphere, the mixture was stirred at 80° C. for 10 minutes to obtain a toluene solution 1. A separately prepared toluene solution (4.27 mL) containing 4-trimethylsilyldiphenylacetylene (1.07 g, 4.27 mmol) was added to the aforementioned toluene solution 1, and the mixture was stirred at 80° C. for 3 hours to obtain a product A. Chloroform (400 mL) was added to the product A, and the product A was dissolved to obtain a chloroform solution 1. The chloroform solution 1 in which product A was dissolved was added to 2400 mL of an acetone/chloroform mixture (acetone:chloroform=1:5 (volume ratio)), to precipitate the target polymer. The precipitate was recovered by filtration, and dried under reduced pressure overnight to obtain a reddish brown polymer at a yield of 67.8% (0.725 g). The obtained polymer was soluble in common organic solvents such as toluene, chloroform or tetrahydrofuran (hereunder, “THF”).

The ¹H NMR spectrum of the obtained polymer exhibited an extremely broad peak. Observation by ¹³C NMR was difficult. The peaks in the IR spectrum were as follows:

IR (Film)ν=3053(ν_{C—H}cm⁻¹, 3016−2897(ν_{Ph-H})cm⁻¹, 1596(ν_{C═C})cm⁻¹, 1492−1387(ν_{Ph C═C})cm⁻¹, 1247(δ_{SiC—H})cm⁻¹, 1117(ν_{Si—CH3})cm⁻¹, 854(_{1,4-Ph})cm⁻¹, 834(ν_{Si—CH3})cm⁻¹, 689(ν_{Si-Ph})cm⁻¹, 552(ν_{Ph C—H})cm⁻¹.

The M_{w}, Mₙ and M_{w}/Mₙ values for the obtained polymer, and the 5% weight reduction temperature (T_{d5}), were determined. The results were as follows:

M_{w}=11.3×10⁶,

Mₙ=5.89×10⁶,

M_{w}/Mₙ=1.92,

T_{d5}=399° C.

A toluene solution of the obtained polymer was prepared (1.0 wt %) and cast onto a glass plate, and the solvent (toluene) was slowly evaporated off at room temperature. The solvent was evaporated off to dryness to form a film. The film was released from the glass plate to obtain a selfstanding polymer film. The thickness of the polymer film determined with a micrometer was 69 μm. The main reaction formula in this polymerization step is shown below.

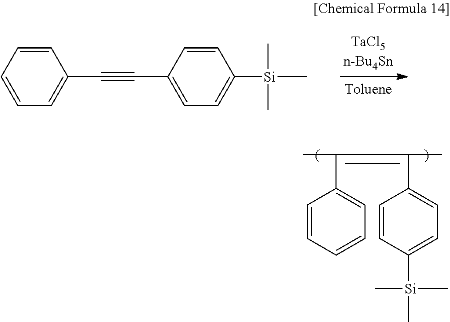

The obtained polymer film (29.0 mg) was then immersed in 2 mL of perfluoro(1,3-dimethylcyclohexane) containing di(perfluorocyclohexylcarboxy)peroxide (3.77 g, 5.80 mmol) under a nitrogen atmosphere, for 5 minutes at room temperature. The film was removed from the solution, further immersed in methanol for 1 hour and then dried at room temperature to obtain a polymer film for Example 1. The main reaction formula in the immersion step is shown below.

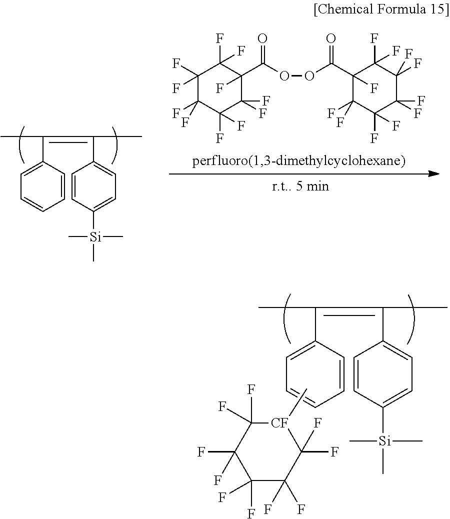

The thickness of the film determined with a micrometer was 87 μm. The peaks in the IR spectrum were as follows: IR (KBr) ν=3057(ν_{C—H})cm⁻¹, 3016(ν_{Ph-H})cm⁻¹, 2955(ν_{C—H})cm⁻¹, 1248(δ_{SiC—H})cm⁻¹, 1203(ν_{C—F})cm⁻¹, 1117(ν_{Si—CH3})cm⁻¹, 855(ν_{Si—CH3})cm¹.

As mentioned above, it was confirmed that the IR spectrum of the polymer film of Example 1 had a C—F bond-derived peak near 1200 cm⁻¹.

### Comparative Example 1

A polydimethylsiloxane film with a thickness of 50 μM was prepared.

### Comparative Example 2

An ethylene tetrafluoride/propylene hexafluoride copolymer film with a thickness of 12.5 μm was prepared.

### [Evaluation of Polymer Films (Gas Permeation Test)]

The oxygen and nitrogen gas permeability coefficients were measured for the polymer films of Example 1 and Comparative Examples 1 and 2. Specifically, the oxygen and nitrogen gas permeability coefficients (P_{O2} and P_{N2}, units: cm³ (STP)·cm/cm²·sec·cmHg) were measured using a gas permeability meter (GTR-30X by GTR Tec Corp.) at 23° C., 60% humidity. The measured P_{O2} and P_{N2} values were used to calculate α_{O2/N2} (=PO_{O2}/P_{N2}), indicating the oxygen/nitrogen selective permeability. Table 1 shows the results of evaluating the films of Example 1 and Comparative Examples 1 and 2.

TABLE 1

| | |
|---|---|
| | Oxygen/nitrogen |
| Permeability | selective |
| coefficient* | permeability |

| | P_{O2} | P_{N2} | α_{O2/N2} |
|---|---|---|---|
| Example 1 | 1780 | 740 | 2.4 |
| Comp. Ex. 1 | 620 | 280 | 2.2 |
| Comp. Ex. 2 | 5.2 | 1.8 | 2.8 |

*Units: 1 × 10⁻¹⁰ cm³(STP)cm/cm² · s · cmHg

Based on these results, it was confirmed that the polymer film of Example 1 has both higher oxygen permeability coefficient and higher oxygen/nitrogen selective permeability compared to the polymer films of Comparative Examples 1 and 2.

1. A polymer having a repeating unit represented by the following formula (1): 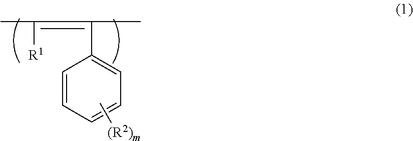
R¹ represents a hydrogen atom, a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group, each R² is independently represented by the following formula (2), m is an integer of from 1 to 5, and when a plurality of R²s are present, the R²s may be the same as or different from each other; 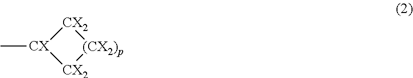
each X is independently a monovalent group, the plurality of Xs may be the same as or different from each other, at least one X is a monovalent group containing a halogen atom, and p is an integer of from 0 to 10.

2. The polymer according to claim 1, wherein at least one X is a halogeno group.

3. The polymer according to claim 1, wherein at least one X is a fluoro group.

4. The polymer according to claim 2, wherein all of the Xs are halogeno groups.

5. The polymer according to claim 3, wherein all of the Xs are fluoro groups.

6. The polymer according to claim 1, wherein R¹ is an unsubstituted phenyl group, or a substituted phenyl group which is represented by the following formula (3): 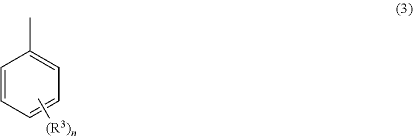
each R³ independently represents a monovalent group, n is an integer of from 1 to 5, and when a plurality of R³s are present, the R³s may be the same as or different from each other.

7. The polymer according to claim 6, wherein R¹ is a substituted phenyl group represented by the formula (3), and each R³ is independently a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group.

8. The polymer according to claim 6, wherein R¹ is a substituted phenyl group represented by the formula (3), and each R³ is independently a halogeno group, a substituted or unsubstituted alkyl group, or a trialkylsilyl group.

9. The polymer according to claim 6, wherein R¹ is a substituted phenyl group represented by the formula (3), and each R³ is independently a fluoro group or a trimethylsilyl group.

10. The polymer according to claim 6, wherein R¹ is a substituted phenyl group represented by the formula (3), and each R³ is independently a trimethylsilyl group.

11. The polymer according to claim 1, wherein R¹ is an unsubstituted phenyl group.

12. A gas separation membrane made of a polymer according to claim 1.

13. A process for producing a polymer, the process comprising a step of subjecting a polymer comprising a repeating unit represented by the following formula (C), into contact with a di(halogenocycloalkylcarboxy)peroxide represented by the following formula (D) or a (halogenocycloalkyl)phenyliodoniumtrifluoromethane sulfonate represented by the following formula (E) or both; 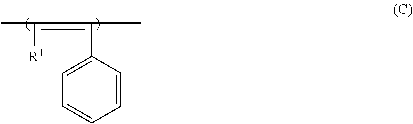
R¹ represents a hydrogen atom, a halogeno group, a substituted or unsubstituted alkyl group, a substituted or unsubstituted aromatic hydrocarbon group, a substituted or unsubstituted aromatic heterocyclic group, a trialkylsilyl group, or a trialkylgermyl group; 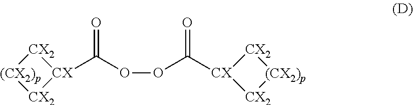
each X is independently a monovalent group, the plurality of Xs may be the same as or different from each other, at least one X is a monovalent group containing a halogen atom, each p is independently an integer of from 0 to 10, and the two p values may be the same as or different from each other; 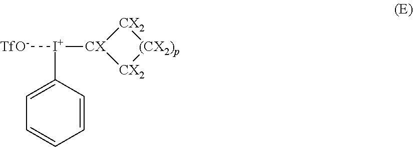
each X is independently a monovalent group, the plurality of Xs may be the same as or different from each other, at least one X is a monovalent group containing a halogen atom, p is an integer of from 0 to 10, and TfO⁻ represents a trifluoromethanesulfonate ion.
